(19) United States
(12) Patent Application Publication
(10) Pub. No.: US 2026/0201165 A1
(43) Pub. Date: Jul. 16, 2026

(54) COMPOSITIONS COMPRISING CLAYS AND THEIR USE FOR THE PREPARATION OF A TUBULAR STRUCTURE TO REDUCE OLIGOMER EXTRACTION

(71) Applicants: ARKEMA FRANCE, Puteaux (FR); SHINIL CHEMICAL INDUSTRY CO LTD, Gyenonggi-do (KR)

(72) Inventors: Hyungmin KIM, Seoul (KR); Nicolas DUFAURE, Serquigny (FR); Antoine GOUPIL, Seoul (KR); Keumsuk SEO, Gyeonggi-do (KR)

(73) Assignees: ARKEMA FRANCE, Puteaux (FR); SHINIL CHEMICAL INDUSTRY CO LTD, Gyenonggi-do (KR)

(21) Appl. No.: 19/138,977

(22) PCT Filed: Dec. 14, 2022
(86) PCT No.: PCT/IB2022/000713

§ 371 Date: Jun. 13, 2025

(51) Int. Cl. C08L 77/02; C08K 3/34; C08L 51/04; F16L 11/14

(52) U.S. Cl. CPC C08L 77/02; C08K 3/346; C08L 51/04; F16L 11/14; C08K 2201/019; C08L 2203/18

(57) ABSTRACT

The present invention relates to the use of a composition comprising at least one polyamide whose average number of carbon atoms per nitrogen atom is greater than 6, in particular greater than or equal to 7, in particular greater than or equal to 8, and clays for the preparation of a tubular structure intended for the transport of fuel, in particular gasoline, in particular alcohol, said tubular structure comprising at least one layer (1) comprising said composition and having a reduction of extractables, in particular oligomers, extracted by said fuel in relation to the same structure comprising the same composition but devoid of clays,
said composition being devoid of a polyamide obtained by polycondensation of meta-xylylene diamine with a dicarboxylic acid Cb in C4 to C36.

The invention concerns compositions comprising clays and their use to reduce oligomer extraction. The invention also concerns a tubular structure for the transport of fuel comprising such a composition.

### PRIOR ART

Car manufacturers are looking to reduce the extraction of compounds present in polyamide gasoline lines, in order to ensure the proper functioning of combustion engines and to guarantee the purity of gasoline.

The extraction of oligomers and plasticizers used in gasoline lines reduces the efficiency of thermal engines (decrease in the purity of gasoline) and can even cause, in the case of oligomers, the blockage of injectors. It is therefore important to reduce the extraction by the essence of these compounds, in particular oligomers not being dissolved in the essence.

Clays are a long-known technology and there are many patents on the barrier effect of clays. However, only KR20210005390 (Shinil Chemical Ind co Ltd) discloses a specific composition based on PA11 or PA12—containing clays, but also carbon nanotubes, MXD6 and a modified ethylene octene rubber (EOR) and mentions an impact on extractables.

However, the use of NTC and MXD6 lowers the flexibility of the tube that is detrimental for the thermoforming and the assembly of said tubes.

Further, long-chain polyamides, in particular PA12, are inherently poor in resistance to component extraction.

Thus, there is a need to provide a composition improving this resistance to component extraction while keeping a good flexibility of the tubes.

The present invention thus concerns the use of a composition comprising at least one polyamide whose average number of carbon atoms per nitrogen atom is greater than 6, in particular greater than or equal to 7, in particular greater than or equal to 8, and clays for the preparation of a tubular structure intended for the transport of fuel, in particular gasoline, in particular alcohol, said tubular structure comprising at least one layer (1) comprising said composition and having a reduction of extractables, in particular oligomers, extracted by said fuel in relation to the same structure comprising the same composition but devoid of clays,
said composition being devoid of a polyamide obtained by polycondensation of meta-xylylene diamine with a dicarboxylic acid Cb in C4 to C36.

The inventors have thus found that a composition comprising a polyamide whose average number of carbon atoms per nitrogen atom is greater than 6, and clays but excluding semi-aromatic polyamides such as a polyamide obtained by polycondensation of meta-xylylene diamine with a dicarboxylic acid Cb in C4 to C36 was allowing to reduce the extraction by the essence of these compounds, in particular oligomers not being dissolved in the essence, while keeping a good flexibility of the tubes prepared with said composition. Such tubes prepared with said composition further present good properties for the thermoforming and their assembly.

The test of extractables developed by different manufacturers, especially Volkswagen, consists in determining the proportion of extractables of a petrol transport tube after bringing the inside thereof into contact with hot alcohol-containing petrol for several hours and weighing the evaporation residue of the petrol contained within the tube, corresponding to the extractables.

The tube tested can then be used for the transport of gasoline only if the proportion of extractables is as low as possible, in particular less than or equal to 8 g/m2, in particular 6, for soluble extractables and less than 1 g/m2, in particular 0.8, for insoluble extractables (inner tube surface).

Oligomers refer to refers to polyamides necessarily of lower number average molecular weight than the polyamides used in the composition, in particular said oligomers have a number average molecular weight of 1000-15000 g/mol, in particular 1000-10000 g/mol.

Thus, the proportion of extractables in a tube prepared with the compostions of the invention present a reduction of extractables, in particular oligomers, extracted by said fuel compared to the proportion of extractables with the same structure comprising the same composition but devoid of clays.

In an embodiment, said composition is devoid of carbon nanotubes.

In another embodiment, said composition is devoid of carbon nanotubes and of a polyamide obtained by polycondensation of meta-xylylene diamine with a dicarboxylic acid Cb in C4 to C36.

In this specification, all the ratio given are in weight relative to the total composition.

### Regarding the Clays

The clay is an inorganic filler that may be a microparticle having a size of 0.1 to 10 nm. The clay may be platy montmorillonite, hectorite, saponite, or vermiculite, and is more preferably platy montmorillonite, hectorite, saponite, or vermiculite, which has been organically pretreated with an organic material.

The organic material may be an organic material including tertiary or quaternary ammonium. The organic material may include one or more ammoniums selected from bis(2-hydroxy-ethyl)methyl tallow ammonium and dimethyl hydrogenated-tallow ammonium. For example, montmorillonite organically treated with bis(2-hydroxy-ethyl)methyl tallow ammonium or montmorillonite organically treated with dimethyl hydrogenated-tallow ammonium may be used as the clay.

The organic material may be an organic material including any one functional group selected from phosphonium, maleate, succinate, acrylate, benzylic hydrogen, dimethyl distearyl ammonium, and oxazoline.

The clay may be mixed clay formed by mixing two or more types of clay selected from platy montmorillonite, hectorite, saponite, and vermiculite, and is more preferably mixed clay formed by mixing two or more types of clay selected from platy montmorillonite, hectorite, saponite, and vermiculite and organically pretreating the mixture. The organically pretreated mixed clay may be formed by mixing two or more types of clay in a reaction tank in preparation of clay and then pretreating the resultant mixture with an organic material.

Advantageously, clays are nanoclays. Nanoclays are layered silicates with single layer of 0.1 to 1 nm thickness.

### Regarding the Polyamide

The nomenclature used to define the polyamides is described in ISO standard 1874-1:2011 “Plastiques—Matériaux polyamides (PA) pour moulage et extrusion—Partie 1: Désignation”, especially on page 3 (Tables 1 and 2) and is well known to the person skilled in the art.

The polyamide of the invention may be a homopolyamide or a copolyamide.

The average number of carbon atoms per nitrogen atom of said polyamide is greater than 6, in particular greater than or equal to 7, in particular greater than or equal to 8.

Advantageously, it is a homopolyamide.

It may be a semi-crystalline or amorphous.

Preferably it is an aliphatic polyamide, in particular a semi-crystalline aliphatic polyamide.

A semi-crystalline polyamide, in the sense of the invention, denotes a polyamide that has a glass transition temperature as determined by dynamic mechanical analysis (DMA) according to ISO standard 6721-11:2019 as well as a melting temperature (Tm) determined according to ISO standard 11357-3:2013, and a crystallization enthalpy during the cooling step at a rate of 20 K/min in DSC measured according to ISO standard 11357-3 of 2013 greater than 30 J/g, preferably greater than 35 J/g.

An amorphous polyamide, in the sense of the invention, denotes a polyamide that has only a glass transition temperature (not a melting temperature (Tm)), or a polyamide that has very little crystallinity having a glass transition temperature and a melting point such that the crystallization enthalpy during the cooling step at a rate of 20 K/min measured according to standard ISO 11357-3:2013 is less than 30 J/g, in particular less than 20 J/g, preferably less than 15 J/g.

In one embodiment, the semi-crystalline aliphatic polyamide is linear.

In one embodiment, the semi-crystalline aliphatic polyamide is a homopolyamide, particularly a semi-crystalline linear aliphatic homopolyamide.

Said at least one semi-crystalline aliphatic polyamide may be obtained from the polycondensation of at least one lactam, said at least one lactam may be selected from a C9 to C18 lactam, preferentially C10 to C18, more preferentially C10 to C12.

A C9 to C12 lactam especially is decanolactam, undecanolactam, and lauryllactam.

Said at least one semi-crystalline aliphatic polyamide may be obtained from the polycondensation of at least one lactam, it may therefore comprise a single lactam or several lactams.

Advantageously, said at least one semi-crystalline aliphatic polyamide is obtained from the polycondensation of a single lactam and said lactam is selected from lauryllactam and undecanolactam, advantageously lauryllactam.

Said at least one semi-crystalline aliphatic polyamide may be obtained from the polycondensation of at least one amino acid, said at least one amino acid may be selected from a C9 to C18 amino acid, preferentially C10 to C18, more preferentially C10 to C12.

An amino acid C9 to C12 is 9-aminononanoic acid, 10-aminodecanoic acid, 10-aminoundecanoic acid, 12-aminododecanoic acid and 11-aminoundecanoic acid and derivatives thereof, especially N-heptyl-11-aminoundecanoic acid.

When said at least one semi-crystalline aliphatic polyamide is obtained from the polycondensation of at least one amino acid, it may therefore comprise a single amino acid or several amino acids.

Advantageously, said semi-crystalline aliphatic polyamide is obtained from the polycondensation of a single amino acid and said amino acid is selected from 11-aminoundecanoic acid and 12-aminododecanoic acid, advantageously 11-aminoundecanoic acid.

Said at least one semi-crystalline aliphatic polyamide may be obtained from the polycondensation of at least one diamine Ca in C4-C36, preferentially C56-C18, preferentially C6-C12, more preferentially C10-C12, with at least one diacid Cb in C4-C36, preferentially C6-C18, preferentially C6-C12, more preferentially C10-C12.

The diamine may be linear or branched. Advantageously, it is linear.

Said at least one C4-C36 diamine Ca can be in particular selected from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and the diamines obtained from fatty acids.

Advantageously, said at least one diamine Ca is C6-C18 and selected from 1,6-hexamethylenediamine, 1,7-heptamethylenediamine, 1,8-octamethylenediamine, 1,9-nonamethylenediamine, 1,10-decamethylenediamine 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C6 to C12 Ca diamine is particularly chosen from 1,6-hexamethylene diamine, 1,7-heptamethylediamine, 1,8-octamethylediamine, 1,9-nonamethylediamine, 1,10-decamethylediamine, 1,11-undecamethylediamine, and 1,12-dodecamethylediamine.

Advantageously, the diamine Ca used is a C10 to C12 diamine, particularly chosen from 1,10-decamethylenediamine, 1,11-undecamethylenediamine, and 1,12-dodecamethylenediamine.

Said at least one C4 to C36 dicarboxylic acid Cb may be selected from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one Cb dicarboxylic acid is C6 to C18 and is chosen from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid.

Advantageously, said at least one Cb dicarboxylic acid is C6 to C12 and can be chosen from adipic acid, suberic acid, azelaic acid, sebacic acid, undecanedioic acid, and dodecanedioic acid.

Advantageously, said at least one Cb dicarboxylic acid is C10 to C12 and is chosen from sebacic acid, undecanedioic acid and dodecanedioic acid.

When said semi-crystalline aliphatic polyamide is obtained from the polycondensation of at least one diamine Ca with at least one dicarboxylic acid Cb and may therefore comprise a single diamine or a plurality of diamines and a single dicarboxylic acid or several dicarboxylic acids.

Advantageously, said semi-crystalline aliphatic polyamide is obtained from the polycondensation of a single diamine Ca with a single dicarboxylic acid Cb.

Advantageously, said aliphatic polyamide is selected from PA10, PA11, PA12, PA1010, PA1012, in particular PA11 and PA12.

In one embodiment, the composition used comprises by weight from 1 to 10% clays;

In another embodiment, the composition used comprises by weight:
from 40 to 99%, in particular from 40 to 98.9% of at least one polyamide whose average number of carbon atoms per nitrogen atom is greater than 6, in particular greater than or equal to 7, in particular greater than or equal to 8, said polyamide being obtained by polycondensation:
at least one amino acid in C9 to C18, preferably C10 to C18, more preferably C10 to C12, or
at least one lactam in C9 to C18, preferably C10 to C18, more preferably C10 to C12, or
at least one diamine Ca in C4 to C36, preferably C6 to C18, preferably C6 to C12, more preferably C10 to C12, with at least one dicarboxylic acid Cb in C4 to C36, preferably C6 to C18, preferably C6 to C12, more preferably C10 to C12;
excluding polycondensation of meta-xylylene diamine with c4-C36 dicarboxylic acid Cb;
from 1 to 10% clays;
from 0 to 30%, in particular from 1 to 30%, of at least one functionalized polyolefin;
from 0 to 15%, in particular from 0.1 to 15% of at least one plasticizer;
from 0 to 5% carbon nanotubes;
from 0 to 2% of an additive,
the sum of all the constituents being 100 wt %.

In still another embodiment, said composition used is constituted by weight:
from 40 to 99%, in particular from 40 to 98.9% of at least one polyamide whose average number of carbon atoms per nitrogen atom is greater than 6, in particular greater than or equal to 7, in particular greater than or equal to 8, said polyamide being obtained by polycondensation:
at least one amino acid in C9 to C18, preferably C10 to C18, more preferably C10 to C12, or
at least one lactam in C9 to C18, preferably C10 to C18, more preferably C10 to C12, or
at least one diamine Ca in C4 to C36, preferably C6 to C18, preferably C6 to C12, more preferably C10 to C12, with at least one dicarboxylic acid Cb in C4 to C36, preferably C6 to C18, preferably C6 to C12, more preferably C10 to C12;
excluding polycondensation of meta-xylylene diamine with c4-C36 dicarboxylic acid Cb;
from 1 to 10% clays;
from 0 to 30%, in particular from 1 to 30%, of at least one functionalized polyolefin;
from 0 to 15%, in particular from 0.1 to 15% of at least one plasticizer;
from 0 to 5% carbon nanotubes;
from 0 to 2% of an additive,
the sum of all the constituents being 100 wt %.

In one embodiment, the decrease in insoluble extractables in the composition used is at least 50%, in particular at least 60%.

In another embodiment, the decrease in soluble extractables in the composition used is at least 10%, in particular at least 15%.

In still another embodiment, the decrease in insoluble extractables is at least 50%, in particular at least 60% and the decrease in soluble extractables is at least 10%, in particular at least 15%.

Advantageously, the composition used has an impact resistance greater than 6 KJ/m2 as determined according to ISO 179-1: 2010/1eA (Charpy impact) on bars of dimension 80 mm×10 mm×4 mm, notched in V, at a temperature of −40° C.+/−2° C. under a relative humidity of 50%+/−10% on dry samples.

### Regarding the Functionalized Polyolefins

The functionalized polyolefin also named (B1) can be a polymer of alpha-olefins having reactive units (functionalities); such reactive units are acid, anhydride, or epoxy functions. As an example, mention may be made of a non functionalized polyolefins named (B2) grafted or co- or ter-polymerized by unsaturated epoxides such as glycidyl (meth)acrylate, or by carboxylic acids or the corresponding salts or esters such as (meth)acrylic acid (which can be completely or partially neutralized by metals such as Zn, etc.) or by carboxylic acid anhydrides such as maleic anhydride.

A non-functionalized polyolefin (B2) is classically a homopolymer or copolymer of alpha-olefins or diolefins, such as for example, ethylene, propylene, 1-butene, 1-octene, butadiene. As examples, mention may be made of:
the homopolymers and copolymers of polyethylene, particularly LDPE, HDPE, LLDPE (linear low-density polyethylene), VLDPE (very low density polyethylene) and metallocene polyethylene.
homopolymers or copolymers of propylene.
ethylene/alpha-olefin copolymers such as ethylene/propylene, EPRs (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.
copolymers of ethylene with at least one product chosen from the salts or esters of unsaturated carboxylic acids such as alkyl (meth)acrylate (for example methyl acrylate), or the vinyl esters of saturated carboxylic acids such as vinyl acetate (EVA), where the proportion of comonomer can reach 40% by weight.

A functionalized polyolefin (B1) is for example a PE/EPR mixture, whose ratio by weight can vary widely, for example between 40/60 and 90/10, said mixture being co-grafted with an anhydride, in particular maleic anhydride, according to a graft rate for example of 0.01 to 5% by weight.

The functionalized polyolefin (B1) can be chosen from the following, maleic anhydride or glycidyl methacrylate grafted, (co)polymers wherein the graft rate is for example from 0.01 to 5% by weight:
of PE, of PP, of copolymers of ethylene with propylene, butene, hexene, or octene containing for example from 35 to 80% by weight of ethylene;
ethylene/alpha-olefin copolymers such as ethylene/propylene, EPRs (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.
ethylene and vinyl acetate copolymers (EVA), containing up to 40% by weight of vinyl acetate;
ethylene and alkyl (meth)acrylate copolymers, containing up to 40% by weight of alkyl (meth)acrylate;
ethylene and vinyl acetate (EVA) and alkyl (meth)acrylate copolymers, containing up to 40% by weight of comonomers.

The functionalized polyolefin (B1) can also be chosen from ethylene/propylene copolymers with a majority of maleic anhydride grafted propylene condensed with a mono-amine polyamide (or a polyamide oligomer) (products described in EP-A-0342066).

The functionalized polyolefin (B1) can also be a co- or terpolymer of at least the following units: (1) ethylene, (2) alkyl (meth)acrylate or vinyl ester of saturated carboxylic acid and (3) anhydride such as maleic anhydride or (meth)acrylic acid or epoxy such as glycidyl (meth)acrylate.

As an example of functionalized polyolefins of the latter type, mention may be made of the following copolymers, where ethylene represents preferably at least 60% by weight and where the termonomer (the function) represents for example from 0.1 to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.

In the preceding copolymers, (meth)acrylic acid can be salified with Zn or Li.

The term “alkyl (meth)acrylate” in (B1) or (B2) denotes C1 to C8 alkyl methacrylates and acrylates, and can be chosen from methyl acrylate, ethyl acrylate, n-butyl acrylate, isobutyl acrylate, 2-ethyl-hexyl acrylate, cyclohexyl acrylate, methyl methacrylate and ethyl methacrylate.

Moreover, the previously cited polyolefins (B1) may also be crosslinked by any appropriate method or agent (diepoxy, diacid, peroxide, etc.); the term functionalized polyolefin also comprises mixtures of the previously cited polyolefins with a difunctional reagent such as a diacid, dianhydride, diepoxy, etc. that can react with these or mixtures of at least two functionalized polyolefins that can react together.

The copolymers mentioned above, (B1) and (B2), may be copolymerized in a statistical or sequenced way and have a linear or branched structure.

The molecular weight, MFI, and density of these polyolefins can also vary widely, which the person skilled in the art will know. MFI, abbreviation for Melt Flow Index, is a measure of fluidity when melted. It is measured according to standard ASTM 1238.

Advantageously the non-functionalized polyolefins (B2) are chosen from homopolymers or copolymers of polypropylene and any ethylene homopolymer or ethylene copolymer and a higher alpha-olefin comonomer such as butene, hexene, octene or 4-methyl-1-pentene. Mention may be made for example of PP, high-density PE, medium-density PE, linear low-density PE, low-density PE, very low-density PE. These polyethylenes are known by the person skilled in the art as being products from a “free-radical” method, from a “Ziegler” catalysis method, or, more recently, from “metallocene” catalysis.

Advantageously, the functionalized polyolefins (B1) are chosen from any polymer comprising alpha-olefin units and units bearing polar reactive functions such as epoxy, carboxylic acid or carboxylic acid anhydride functions. As examples of such polymers, mention may be made of terpolymers of ethylene, alkyl acrylate and maleic anhydride or glycidyl methacrylate like Lotader® from the Applicant or polyolefins grafted by maleic anhydride like Orevac® from the Applicant and terpolymers of ethylene, alkyl acrylate and (meth)acrylic acid. Mention may also be made of homopolymers or copolymers of polypropylene grafted by a carboxylic acid anhydride then condensed with polyamides or monoamine polyamide oligomers.

### Regarding the Plasticizers

The plasticizer may be present or not. If it is present, its weight ratio in the composition is up to 15%.

As an example, the plasticisers are chosen from benzene sulfonamide derivatives, such as n-butylbenzenesulfonamide (BBSA); ethyl toluenesulfonamide or N-cyclohexyl toluenesulfonamide; hydroxybenzoic acid esters, such as 2-ethylhexyl parahydroxybenzoate and 2-decylhexyl parahydroxybenzoate; esters or ethers of tetrahydrofurfuryl alcohol, such as oligoethyleneoxytetrahydrofurfuryl alcohol; and esters of citric acid or of hydroxymalonic acid, such as oligoethyleneoxy malonate.

Using a mixture of plasticisers would not be outside the scope of the invention.

### Regarding the Additives

The additive may be present from 0 to 2% by weight in the composition.

Clays are excluded from the scope of the additives.

The additives optionally used in the compositions of the invention are the conventional additives used in polyamides and are well known to a person skilled in the art and are described notably in EP 2098580.

For example, they comprise an anti-static filler selected from carbon black, graphite, carbon fibers, carbon nanotubes, in particular carbon black and carbon nanotubes, an antioxidant, a heat stabilizer, a UV absorber, a light stabilizer, a lubricant, an inorganic filler, a fire-proofing agent, a nucleating agent and a dye, reinforcing fibers, a wax and the mixtures thereof.

Advantageously, additives are selected among an anti-static filler selected from carbon black, graphite, carbon fibers, in particular carbon black, an antioxidant, a heat stabilizer, a UV absorber, a light stabilizer, a lubricant, an inorganic filler, a fire-proofing agent, a nucleating agent and a dye, reinforcing fibers, a wax and the mixtures thereof.

More advantageously, additives are selected among an antioxidant, a heat stabilizer, a UV absorber, a light stabilizer, a lubricant, an inorganic filler, a fire-proofing agent, a nucleating agent and a dye, reinforcing fibers, a wax and the mixtures thereof.

As an example, the stabilizer can be a UV stabilizer, an organic stabilizer or more generally a combination of organic stabilizers, such as a phenol antioxidant (for example of the type Irganox® 245 or 1098 or 1010 by Ciba-BASF), a phosphite antioxidant (for example Irgafos® 126 and Irgafos® 168 by Ciba-BASF) and optionally other stabilizers such as a HALS, which means Hindered Amine Light Stabilizer (for example Tinuvin® 770 by Ciba-BASF), an anti-UV (for example Tinuvin® 312 by Ciba), or a phosphorus-based stabilizer. Amine antioxidants such as Crompton's Naugard® 445 or polyfunctional stabilizers such as Clariant's Nylostab® S-EED can also be used.

This stabilizer may also be a mineral stabilizer, such as a copper-based stabilizer. As an example of such mineral stabilizers, mention may be made of halides and copper acetates. Secondarily, other metals such as silver can optionally be considered, but these are known to be less effective. These compounds containing copper are typically associated with alkali metal halides, particularly potassium.

### Regarding the Tubular Structure

In another aspect, the present invention relates to a tubular structure for the transport of fuel, in particular gasoline, in particular alcoholic, said tubular structure comprising at least one layer (1) comprising a composition as defined above.

All the characteristics cited above for the use of the composition apply also to the tubular structure comprising at least one layer (1) comprising a composition as defined above.

In a first variant, the tubular structure is a monolayer structure.

In one embodiment, said tubular structure comprises further at least one barrier layer (2) selected from EVOH or PPA, said layer (1) being in contact with the fuel.

The expression “barrier layer” means that the layer is highly impermeable to the fluids transported.

The term “PPA” means a semi-aromatic polyamide or a polyphtalamide (PPA).

Said semi-aromatic polyamide of the barrier layer is notably a semi-aromatic polyamide of formula X/YAr, as described in EP1505099, notably a semi-aromatic polyamide of formula D/XT, wherein D is selected from a unit obtained from an amino acid, a unit obtained from a lactam, and a unit corresponding to the formula (Ca diamine).(Cb diacid), with a representing the number of carbon atoms of the diamine and b representing the number of carbon atoms of the diacid, a and b each being between 4 and 36, advantageously between 9 and 18;

X.T denotes a unit obtained from the polycondensation of a Cx diamine and terephthalic acid, with x representing the number of carbon atoms of the Cx diamine, x being between 6 and 36, advantageously between 9 and 18,
notably a polyamide of formula D/6T, D/9T, D/10T or D/11T, D being as defined above, in particular a polyamide PA 6/6T, 66/6T, 61/6T, PA11/10T, 11/6T/10T, MXDT/10T or MPMDT/10T, BACT/10T aramide, and the block copolymers, in particular polyamide/polyether (PEBA) or
or a copolyamide X2T/X′2Ar, X2 and X′2 each representing, independently of each other, a linear or branched C6-C13 aliphatic diamine, notably, the semi-aromatic polyamide is selected from PA9T, PA9T/9′T, PA10T/6T, PA6T/61, PA6T/66.
9′ corresponds to the nonanediamine positional isomer methyloctanediamine.

In a second variant, the tubular structure is a bilayer structure comprising or constituted of, from outside to inside:
EVOH//(1) or PPA//(1).

In one embodiment, said tubular structure comprising further at least one barrier layer (2) selected from EVOH or PPA comprises at least one outermost layer (3) located above the barrier layer (2), said outer layer (3) comprising mainly at least one aliphatic type polyamide or consisting of more than 75% aliphatic units, in particular said aliphatic polyamide having an average number of carbon atoms per nitrogen atom included from 9.5 to 18, advantageously from 11 to 18.

Said aliphatic polyamide is as defined above.

In a third variant, the tubular structure is a three-layer structure constituted, from outside to inside:
(3)//EVOH//(1) or (3)//PPA//(1).

In one embodiment, said tubular structure comprising further at least one barrier layer (2) selected from EVOH or PPA or at least one outermost layer (3) located above the barrier layer (2) further comprises at least one layer (4), said layer (4) comprising mainly at least one aliphatic type polyamide or consisting of more than 75% aliphatic units, said aliphatic polyamide being selected from:
a polyamide denoted A having an average number of carbon atoms per nitrogen atom denoted CA comprising from 4 to 8.5, preferably from 4 to 7;
a polyamide denoted B and an average number of carbon atoms per nitrogen atom denoted CB included from 7 to 10, preferably from 7.5 to 9.5;
a polyamide denoted C having an average number of carbon atoms per nitrogen atom denoted CC included from 9 to 18, preferably from 10 to 18;
   provided that where the said layer (4) comprises at least three polyamides, at least one of those polyamides A, B or C is excluded,
   said layer (4) being located between the barrier layer (2) and the layer (1) and/or between the outer layer (3) and the barrier layer (2);
   or said layer (4) is a layer of binder whose thickness represents up to 15% of the structure (MLT).

In a fourth variant, the tubular structure is a three-layer structure constituted, from outside to inside:
EVOH//(4)//(1) or PPA//(4)//(1).

In a fifth variant, the tubular structure is a four-layer structure constituted, from outside to inside:
(3)//(4)//EVOH//(1) or (3)//(4)//PPA//(1).

In a sixth variant, the tubular structure is a five-layer structure constituted, from outside to inside:
(3)//(4)//EVOH//(4)//(1) or (3)//(4)//PPA//(4)//(1).

In another embodiment, a layer (4′) is present, said layer (4′) comprising mainly at least one aliphatic polyamide or consisting of more than 75% aliphatic units, said aliphatic polyamide being selected from:
a polyamide denoted A having an average number of carbon atoms per nitrogen atom denoted CA comprising from 4 to 8.5, preferably from 4 to 7;
a polyamide denoted B and an average number of carbon atoms per nitrogen atom denoted CB included from 7 to 10, preferably from 7.5 to 9.5;
a polyamide denoted C having an average number of carbon atoms per nitrogen atom denoted CC included from 9 to 18, preferably from 10 to 18;
   provided that where the said layer (4′) comprises at least three polyamides, at least one of those polyamides A, B or C is excluded,
   or said layer (4′) is a layer of binder whose thickness represents up to 15% of the structure (MLT),
   said at least polyamide of said layer (4′) may be identical or different said polyamide of layer (4);
   said layer (4′) being located between the outer layer (3) and the barrier layer (2) and said binder layer (4) being located between the barrier layer (2) and the layer (1).

The aliphatic polyamide is as defined above.

In a seventh variant, the tubular structure is a five-layer structure constituted, from outside to inside:
(3)//(4′)//EVOH//(4)//(1) or (3)//(4′)//PPA//(4)//(1), layer (4) being a binder layer.

### Regarding the Composition as Such.

In another aspect, the present invention relates to a composition comprising by weight:
from 40 to 98%, in particular 40 to 97.9% of at least one polyamide whose average number of carbon atoms per nitrogen atom is greater than 6, in particular greater than or equal to 7, in particular greater than or equal to 8, said polyamide being obtained by polycondensation:
of at least one amino acid in C9 to C18, preferably C10 to C18, more preferably C10 to C12, or
of at least one lactam in C9 to C18, preferably C10 to C18, more preferably C10 to C12, or
of at least one diamine Ca in C4 to C36, preferably C6 to C18, preferably C6 to C12, more preferably C10 to C12, with at least one dicarboxylic acid Cb in C4 to C36, preferably C6 to C18, preferably C6 to C12, more preferably C10 to C12,
excluding polycondensation of meta-xylylene diamine with C4 to C36 dicarboxylic acid Cb;
from 1 to 10% clays;
from 1 to 30% of at least one functionalized polyolefin;
from 0 to 15%, in particular from 0.1 to 15% of at least one plasticizer;
from 0 to 5% carbon nanotubes;
from 0 to 2% of at least one additive,
the sum of all the constituents being 100 wt %.

All the characteristics cited above for the use of the composition apply also to the composition as such.

In another embodiment, the composition defined in the precedent embodiment is devoid of carbon nanotubes.

In still another embodiment, the present invention relates to a composition constituted by weight:
from 40 to 98%, in particular 40 to 97.9% of at least one polyamide whose average number of carbon atoms per nitrogen atom is greater than 6, in particular greater than or equal to 7, in particular greater than or equal to 8, said polyamide being obtained by polycondensation:
of at least one amino acid in C9 to C18, preferably C10 to C18, more preferably C10 to C12, or
of at least one lactam in C9 to C18, preferably C10 to C18, more preferably C10 to C12, or
of at least one diamine Ca in C4 to C36, preferably C6 to C18, preferably C6 to C12, more preferably C10 to C12, with at least one dicarboxylic acid Cb in C4 to C36, preferably C6 to C18, preferably C6 to C12, more preferably C10 to C12,
excluding polycondensation of meta-xylylene diamine with C4 to C36 dicarboxylic acid Cb;
from 1 to 10% clays;
from 1 to 30% of at least one functionalized polyolefin;
from 0 to 15%, in particular from 0.1 to 15% of at least one plasticizer;
from 0 to 5% carbon nanotubes;
from 0 to 2% of at least one additive,
the sum of all the constituents being 100 wt %.

### EXAMPLES

Hereinafter, the present invention will be described in greater detail through specific examples. The following examples are merely illustrative in order to help understanding of the present invention, and the scope of the present invention is not limited thereto.

### Preparation of Organically Pre-Treated Clay Component

First, montmorillonite, hectorite, and saponite which were dispersed in water and from which impurities were removed were added at a weight ratio of 1:1:1, and were mixed on a condition at a temperature of 60° C. while being agitated, and a clay component dispersion solution was produced. Next, dimethyl hydrogenated-tallow ammonium, which was tertiary ammonium that was adjusted to 4 to 5 pH and then dissolved in the clay component dispersion solution at a temperature of 60° C., was added in a reaction tank by 90 milli equivalents per 100 g of the clay component dispersion solution, and was subjected to an exchange reaction for about 20 to 60 minutes at a temperature of 60° C. while being agitated, and a clay component was produced. Then, the clay component reacted using a filtering device was dried in a fluid dryer, and then a powder having a size between 10 to 40 micrometers was obtained using a milling device.

### Production of Polyamide Composite Resin

Examples 1 and 2 and Comparative Examples 1 to 4 were mixed at a component ratio set forth in Table 1 below, and then polyamide composite resins were produced using a twin-screw extruder. A resin, a rubber, a heat-resistant stabilizer, a lubricant, and a viscosity thickener were injected through a main feeder, and the organically pre-treated clay component was injected and produced through a side feeder. In the case where the clay component was injected into the main feeder, a coagulation phenomenon of the clay component might occur, and thus the clay component was preferably injected using the side feeder or a spray method. A device in which disordered kneading was possible to improve dispersibility could be used as a screw of the extruder. Further, an extrusion temperature in a kneading region was preferably maintained at a temperature of 250° C. or less. When the extrusion temperature was greater than 250° C., a domain size was excessively made fine, and a barrier characteristic could be reduced. The kneaded polyamide composite material was pelletized through a cutter, and then was dried using a dehumidifying dryer.

TABLE 1

| | Ex | Ex | Ex | Ex | | |
|---|---|---|---|---|---|---|
| Wt % | comp1 | comp2 | comp3 | comp4 | Ex 1 | Ex 2 |
| PA12 | 88 | 98 | 70 | 77.5 | 80 | 85 |
| MXD6 | 0 | 0 | 10 | 0 | 0 | 0 |
| CNT | 0 | 0 | 0 | 2.5 | 0 | 0 |
| Rubber | 5 | 0 | 10 | 10 | 10 | 10 |
| Clay | 0 | 0 | 3 | 3 | 3 | 3 |
| Plasticizer | 5 | 0 | 5 | 5 | 5 | 0 |
| additives | 2 | 2 | 2 | 2 | 2 | 2 |

Evaluation of Mechanical Properties (Notched Charpy) and Evaluation of Soluble and non soluble washout of Examples 1 and 2 and Comparative Examples 1 to 4.

The results are provided in Table 2.

TABLE 2

| | Ex | Ex | Ex | Ex | | |
|---|---|---|---|---|---|---|
| | comp 1 | comp 2 | comp 3 | comp 4 | Ex 1 | Ex 2 |
| Soluble | 25.5 | 18 | 21 | 21.5 | 21.5 | 15 |
| washout | | | | | | |
| (g/m2) (of | | | | | | |
| tube inner | | | | | | |
| surface | | | | | | |
| area). | | | | | | |
| Non-sol | 1.5 | 1.7 | 0.6 | 0.8 | 0.6 | 0.7 |
| washout | | | | | | |
| (g/m2) (of | | | | | | |
| tube inner | | | | | | |
| surface | | | | | | |
| area). | | | | | | |
| Notched | 7 | 8 | 4 | 3 | 7 | 8 |
| Charpy −40° | | | | | | |
| C. (kJ/m2) | | | | | | |

Plasticizer: N-Butyl Benzene Sulfonamide (BBSA)
Rubber: maleic anhydride-grafted ethylene-octene copolymer
Additives: carbon black, thermal and UV stabilization
CNT: Multi-hole carbon nanotube

Cold impact according to ISO 179-1: 2010/1eA (Charpy impact) on bars of dimension 80 mm×10 mm×4 mm, notched in V, at a temperature of −40° C.+/−2° C. under a relative humidity of 50%+/−10% on dry samples.

### Soluble Washout and Non Soluble Washout:

This test consisting of a tube filled with alcohol-containing petrol of FAM B type at 60° C. for 96 hours, then 24 hours at 23° C. and then emptied and filtered into a beaker.

The alcohol-containing petrol FAM B is described in standards DIN 51604-1: 1982, DIN 51604-2: 1984 and DIN 51604-3: 1984.

Briefly, the alcohol-containing petrol FAM A is firstly prepared with a mixture of 50% of toluene, 30% of isooctane, 15% of diisobutylene and 5% of ethanol then FAM B is prepared by mixing 84.5% of FAM A with 15% of methanol and 0.5% of water.

FAM B consists in total of 42.3% of toluene, 25.4% of isooctane, 12.7% of diisobutylene, 4.2% of ethanol, 15% of methanol and 0.5% of water.

The dry filter is weight (non soluble washout) and the residual is weight after filtered fuel evaporation (soluble washout), each weight (soluble and non soluble) is expressed by g/m2 of tube inner surface area.

Example 1 and 2 provide the best compromise for the three properties (Notched Charpy, Soluble and non soluble washout) compared to Comparative Examples 1 to 4.

1. A method of preparing a tubular structure configured for the transport of a fuel, the method comprising preparing the tubular structure with a composition comprising at least one polyamide whose average number of carbon atoms per nitrogen atom is greater than 6, said tubular structure comprising at least one layer comprising said composition and having a reduction of extractables, in particular oligomers, extracted by said fuel in relation to the same structure comprising the same composition but devoid of clays,
said composition being devoid of a polyamide obtained by polycondensation of meta-xylylene diamine with a dicarboxylic acid Cb in C4 to C36.

2. The method according to claim 1, wherein said composition is devoid of carbon nanotubes.

3. The method according to claim 1, wherein the composition comprises from 1 to 10% by weight of clays.

4. The method according to claim 1, wherein the decrease in insoluble extractables is at least 50%.

5. The method according to claim 1, wherein the decrease in soluble extractables is at least 10%.

6. The method Use according to claim 1, wherein the decrease in insoluble extractables is at least 50% and the decrease in soluble extractables is at least 10%.

7. The method according to claim 1, wherein the composition comprises by weight:
from 40 to 99% of at least one polyamide whose average number of carbon atoms per nitrogen atom is greater than 6, said polyamide being obtained by polycondensation:
at least one amino acid in C9 to C18, or
at least one lactam in C9 to C18, or
at least one diamine Ca in C4 to C36, with at least one dicarboxylic acid Cb in C4 to C36,
excluding polycondensation of meta-xylylene diamine with c4-C36 dicarboxylic acid Cb;
from 1 to 10% clays;
from 0 to 30%, in particular from 1 to 30%, of at least one functionalized polyolefin;
from 0 to 15% of at least one plasticizer;
from 0 to 5% carbon nanotubes;
from 0 to 2% of an additive
the sum of all the constituents being 100 wt %.

8. The method according to claim 1, wherein said polyamide is an aliphatic polyamide.

9. The method according to claim 8, wherein said aliphatic polyamide is selected from PA10, PA11, PA12, PA1010, PA1012.

10. The method according to claim 1, wherein the composition has an impact resistance greater than 6 KJ/m2 as determined according to ISO 179-1: 2010/1eA (Charpy impact) on bars of dimension 80 mm×10 mm×4 mm, notched in V, at a temperature of −40° C.+/−2° C. under a relative humidity of 50%+/−10% on dry samples.

11. Tubular structure for the transport of fuel, said tubular structure comprising at least one layer comprising a composition comprising at least one polyamide whose average number of carbon atoms per nitrogen atom is greater than 6 and clays, said tubular structure having a reduction of extractables, in particular oligomers, extracted by said fuel in relation to the same structure comprising the same composition but devoid of clays, said composition being devoid of a polyamide obtained by polycondensation of meta-xylylene diamine with a dicarboxylic acid Cb in C4 to C36.

12. Tubular structure according to claim 11, wherein said structure comprises further at least one barrier layer selected from EVOH or PPA, said layer being in contact with the fuel.

13. Tubular structure according to claim 12, wherein at least one outermost layer located above the barrier layer is present, said outer layer comprising mainly at least one aliphatic type polyamide or consisting of more than 75% aliphatic units, in particular said aliphatic polyamide having an average number of carbon atoms per nitrogen atom included from 9.5 to 18.

14. Tubular structure according to claim 12, wherein at least one additional layer is present, said addition layer comprising mainly at least one aliphatic type polyamide or consisting of more than 75% aliphatic units, said aliphatic polyamide being selected from:
a polyamide denoted A having an average number of carbon atoms per nitrogen atom denoted CA comprising from 4 to 8.5;
a polyamide denoted B and an average number of carbon atoms per nitrogen atom denoted CB included from 7 to 10;
a polyamide denoted C having an average number of carbon atoms per nitrogen atom denoted CC included from 9 to 18;
provided that where the said additional layer comprises at least three polyamides, at least one of those polyamides A, B or C is excluded,
said additional layer being located between the barrier layer and the layer and/or between the outer layer and the barrier layer;
or said additional layer is a layer of binder whose thickness represents up to 15% of the structure (MLT).

15. Tubular structure according to claim 14, wherein a further layer is present, said further layer comprising mainly at least one aliphatic polyamide or consisting of more than 75% aliphatic units, said aliphatic polyamide being selected from:
a polyamide denoted A having an average number of carbon atoms per nitrogen atom denoted CA comprising from 4 to 8.5;
a polyamide denoted B and an average number of carbon atoms per nitrogen atom denoted CB included from 7 to 10;
a polyamide denoted C having an average number of carbon atoms per nitrogen atom denoted CC included from 9 to 18;
provided that where the said further layer comprises at least three polyamides, at least one of those polyamides A, B or C is excluded,
or said further layer is a layer of binder whose thickness represents up to 15% of the structure (MLT),
said at least polyamide of said further layer may be identical or different said polyamide of said additional layer;
said further layer being located between the outer layer and the barrier layer and said additional layer being located between the barrier layer and the layer.

16. Composition comprising by weight:
from 40 to 98% of at least one polyamide whose average number of carbon atoms per nitrogen atom is greater than 6, said polyamide being obtained by polycondensation:
of at least one amino acid in C9 to C18, or
of at least one lactam in C9 to C18, or
of at least one diamine Ca in C4 to C36, with at least one dicarboxylic acid Cb in C4 to C36,
excluding polycondensation of meta-xylylene diamine with C4 to C36 dicarboxylic acid Cb;
from 1 to 10% clays;
from 1 to 30% of at least one functionalized polyolefin;
from 0 to 15%, in particular from 0.1 to 15% of at least one plasticizer;
from 0 to 5% carbon nanotubes;
from 0 to 2% of at least one additive
the sum of all the constituents being 100 wt %.

17. A composition according to claim 16, wherein the composition is devoid of carbon nanotubes.
